(19) United States
(12) Patent Application Publication
(10) Pub. No.: US 2023/0126900 A1
(43) Pub. Date: Apr. 27, 2023

(54) METHOD AND APPARATUS FOR CELL FOLD ADHESION WHEN FILLING A BATTERY MODULE WITH THERMAL PASTE

(71) Applicant: Dr. Ing. h.c. F. Porsche Aktiengesellschaft, Stuttgart (DE)

(72) Inventors: Immanuel Vogel, Steinheim (DE); Sascha Mostofi, Stuttgart (DE); Christopher Volkmer, Niefern-Öschelbronn (DE); Philipp Kellner, Renningen (DE)

(73) Assignee: Dr. Ing. h.c. F. Porsche Aktiengesellschaft, Stuttgart (DE)

(21) Appl. No.: 17/972,660

(22) Filed: Oct. 25, 2022

(30) Foreign Application Priority Data
Oct. 26, 2021 (DE) 10 2021 127 842.2

(51) Int. Cl. H01M 10/653; H01M 10/613; H01M 50/211; H01M 50/60; H01M 10/6554; H01M 50/136

(52) U.S. Cl. CPC H01M 10/653; H01M 10/613; H01M 50/211; H01M 50/60; H01M 10/6554; H01M 50/136; H01M 2220/20

(57) ABSTRACT

A method for filling a thermal paste into a battery module. The battery module includes a module housing with at least one cooling wall, at which a cooling plate can be arranged outside the module housing. At least one stack is formed by a plurality of uniformly stacked pouch cells. The at least one stack is arranged at the at least one cooling wall in the module housing. In proximity to at least one opening, a fold of at least one pouch cell is folded over toward the surface of pouch cell and glued, thereby forming a first flow channel between a stack cooling side and the cooling wall. The thermal paste is filled in through the opening and the thermal paste spreads homogeneously in the first flow channel.

### CROSS-REFERENCE TO RELATED APPLICATION

This application claims priority to German Patent Application No. 10 2021 127 842.2, filed Oct. 26, 2021, the content of such application being incorporated by reference herein in its entirety.

### FIELD OF THE INVENTION

The present invention relates to a method for providing a modular traction battery cooled via a thermal paste and having pouch cells. Furthermore, a battery module which allows the method to be carried out.

### BACKGROUND OF THE INVENTION

During charging or discharging operations on battery cells in a traction battery of an electric vehicle, heat generation takes place, which can damage the battery. In order to ensure a long service life of the battery cells, the battery must therefore be cooled. According to the prior art, such cooling can take place by a separate cooling system with a coolant, for example by attaching a cooling plate to the battery housing. The cooling plate or cooling lines of the cooling system may, for example, be thermally connected to the battery cells via a thermal paste, wherein the thermal paste is located between battery cells and battery housing. Since dissipation of the produced heat is more effective the better the thermal paste encloses the battery cells, the thermal paste should fill the intermediate space as homogeneously as possible and with the inclusion of as few air voids as possible.

One design of the battery cell known in the prior art is the so-called pouch cell, also referred to in German as Taschenzelle [literally: “pocket cell”], in which, for example, a lithium-ion battery in a planar form is welded in between two films. This produces an edge layer, the so-called fold, which surrounds the lithium ion battery and in which the two films are directly connected to one another. The fold is flexible like the two films and can, for example, be bent over in order to better define the spatial extent of the pouch cell.

DE 10 2013 016 618 A1, which is incorporated by reference herein, discloses a battery cell which is welded in between films and which, in a multitude stacked on top of one another, forms a battery. In order to obtain a defined shape of the stack, a circumferential sealed seam or the fold of the respective battery cells is either rolled up or folded over at least twice at least at one edge region.

DE 10 2015 115 601 A1, which is incorporated by reference herein, describes a battery system in which a respective edge region of a pouch cell is received in a groove of a frame-shaped edge element. The respective edge region of the pouch cell is thermally coupled to the edge element with the aid of a thermal paste.

US 20130344372 A1, which is incorporated by reference herein, discloses a body that allows a defined bending of the fold of a pouch cell. Bursting of the fold or tears along the fold are thus avoided.

### SUMMARY OF THE INVENTION

In light of the foregoing, described herein is a method for providing a traction battery cooled zo via a thermal paste and having pouch cells, wherein the thermal paste is distributed between the pouch cells and battery housing as homogeneous as possible and with the inclusion of as few air voids as possible. Moreover, an apparatus that allows the method to be carried out is to be provided.

In order to solve the aforementioned task, a method for filling a thermal paste into a battery module is proposed, wherein the battery module comprises a module housing with at least one cooling wall at which a respective cooling plate can be arranged outside the module housing. A respective pouch cell is formed as a rectangular surface with a length and a width and, perpendicularly to the surface, has an edge with a pouch cell thickness, wherein a fold extends along the edge. At least one stack is formed by a plurality of pouch cells uniformly stacked on top of one another on their flat sides. At least one stack cooling side is spanned by a pouch cell longitudinal direction and a stacking direction formed in the direction of stacking. In the module housing, the at least one stack with its at least one stack cooling side is arranged at the at least one cooling wall. In the at least one cooling wall, at least one opening is arranged, which lies centrally to the length of the pouch cell, for example. However, a plurality of openings may also be distributed along the pouch cell longitudinal direction. In proximity to the at least one opening, a fold, extending on the at least one stack cooling side, of at least one pouch cell is folded over toward the surface of this at least one pouch cell and glued. A first flow channel is thereby formed between the stack cooling side and the at least one cooling wall. The thermal paste is filled in through the at least one opening and homogeneously spreads in the first flow channel.

When carrying out the method according to aspects of the invention, the thermal paste fills an intermediate space between the at least one stack cooling side and the at least one cooling wall and advantageously thermally bonds the at least one stack of pouch cells to the at least one cooling wall of the battery module. At the outer side of the at least one cooling wall, a respective cooling plate is or is to be thermally contacted so that the pouch cells are cooled via the at least one cooling wall and the thermal paste during operation. In manufacturing, when the battery module is assembled after the at least one stack of pouch cells with folds bent over and/or glued according to aspects of the invention has been arranged in the module housing, the thermal paste is pressed or injected into the module housing. As a result of the formation of the first flow channel according to aspects of the invention, the thermal paste spreads advantageously homogeneously and an inclusion of air voids when the thermal paste spreads within the intermediate space is reduced as much as possible, which makes a higher cooling capacity possible overall. Further advantageously, a high rapid charging and discharging capacity of the battery module or of a traction battery having such battery modules thus also results.

As is known from flow mechanics, flat bodies in the flow field experience a torque which places them transversely to the flow direction. When filling the thermal paste into the intermediate space, a fold that is only bent over but not further fixed to form the first flow channel would therefore straighten up again and stand transversely to the flow direction of the thermal paste, thereby constricting the first flow channel. A uniform distribution of the thermal paste in the stacking direction would thus be more difficult, which disadvantageously leads to pore formation in the intermediate space and results in a worse cooling capacity. However, by the adhesion of the bent-over fold according to aspects of the invention, the fold undesirably standing up when the thermal paste is filled in is advantageously prevented and the first flow channel for the thermal paste in the stacking direction is ensured.

The respective cooling plate is connected to, for example, a cooling system of an electrical traction system and is integrated in the cooling circuit thereof. The electrical traction system is, for example, a drive of an electric vehicle or of a hybrid vehicle driven at least in part electrically. The cooling system comprises, for example, a cooler ventilated with a cooling air, and a coolant pump. The cooling air is formed, for example, by the airflow of a moving electric vehicle.

Thermal contact of the respective cooling plate with the at least one cooling wall may be aided, for example, by a planar application of the cooling paste between the respective cooling plate and the at least one cooling wall of the battery module. In a preferred embodiment of the method according to aspects of the invention, the battery module comprises two cooling walls on opposite sides of the battery module, in which the intermediate space to the at least one stack of pouch cells arranged within the battery module is respectively filled with thermal paste. In a type of sandwich structure, respective cooling plates are arranged on both cooling walls, wherein it is conceivable that a further battery module can be arranged on the respectively free side of the cooling plate. A plurality of combinations of battery modules and cooling plates may, for example, be assembled in a battery box to form a battery system that is part of the electrical traction system. However, it is also conceivable that the cooling wall of the battery module is thermally contacted with zo a wall of the battery box and that a cooling plate is arranged externally on the wall of the battery box.

In one embodiment of the method according to aspects of the invention, the first flow channel is formed in the stacking direction and orthogonally to the pouch cell longitudinal direction by taping the folds and by hollowing out the stack-side cooling wall.

In a further embodiment of the method according to aspects of the invention, a respective fold is glued individually to its respective pouch cell.

In another embodiment of the method according to aspects of the invention, a respective fold is taped in a group with further folds with an adhesive tape arranged along the stacking direction.

In a still further embodiment of the method according to aspects of the invention, at least one second flow channel is formed orthogonally to the first flow channel by additionally bending over and taping at least one fold along the pouch cell longitudinal direction.

In a continued yet further embodiment of the method according to aspects of the invention, the first flow channel is formed with a larger volume than the second flow channel by more narrowly taping and/or more strongly hollowing out the stack-side cooling wall. As a result, the thermal paste spreads first in the first flow channel and subsequently in the second flow channel during filling.

Furthermore, a battery module comprises a module housing with at least one cooling wall at which a cooling plate can be arranged outside the module housing. A respective pouch cell is formed as a rectangular surface with a length and a width and, perpendicularly to the surface, has an edge with a pouch cell thickness, wherein a fold extends along the edge. At least one stack is formed by a plurality of pouch cells uniformly stacked on top of one another on their planar sides. At least one stack cooling side is spanned by a pouch cell longitudinal direction and a stacking direction formed in the direction of stacking. In the module housing, the at least one stack with its at least one stack cooling side is arranged at the at least one cooling wall. In the at least one cooling wall, at least one opening is arranged, which lies centrally to the length of the pouch cell, for example. However, a plurality of openings may also be distributed along the pouch cell longitudinal direction. In proximity to the at least one opening, a fold, extending on the at least one stack cooling side, of at least one pouch cell is folded over toward the surface of this at least one pouch cell and glued. A first flow channel is thereby formed between the at least one stack cooling side and the at least one cooling wall. The thermal paste can be filled in through the at least one opening, wherein the first flow channel is configured such that the thermal paste spreads homogeneously between the at least one stack cooling side and the at least one cooling wall.

In one embodiment of the battery module according to aspects of the invention, the first flow channel is formed in the stacking direction and orthogonally to the pouch cell longitudinal direction by taping the folds and by hollowing out the stack-side cooling wall.

In a further embodiment of the battery module according to aspects of the invention, a respective fold is individually glued to its respective pouch cell.

In another embodiment of the battery module according to aspects of the invention, a respective fold is taped in a group with further folds with an adhesive tape arranged along the stacking direction.

In a still further embodiment of the battery module according to aspects of the invention, at least one second flow channel is formed orthogonally to the first flow channel by additionally bending over and taping at least one fold along the pouch cell longitudinal direction.

In a continued yet further embodiment of the battery module according to aspects of the invention, the first flow channel is formed with a larger volume than the second flow channel by more narrowly taping and/or more strongly hollowing out the stack-side cooling wall. The first flow channel and the second flow channel are thereby configured such that when the thermal paste is filled in, the latter spreads first in the first flow channel and subsequently in the second flow channel.

Additional advantages and embodiments of the invention result from the description and the enclosed drawing.

It goes without saying that the features mentioned above and the features yet to be explained below can be used not only in the respectively specified combination but also in other combinations or alone, without leaving the scope of the present invention.

### BRIEF DESCRIPTION OF THE DRAWINGS

The figures are described contiguously and comprehensively, and the same components are associated with the same reference numbers.

FIG. 1 schematically shows a perspective representation of a pouch cell in one embodiment of the method according to aspects of the invention.

FIG. 2 schematically shows a sectional view through a battery module in a further embodiment of the method according to aspects of the invention.

FIG. 3 schematically shows a phantom view through the battery module from above in a still further embodiment of the method according to aspects of the invention.

### DETAILED DESCRIPTION OF THE INVENTION

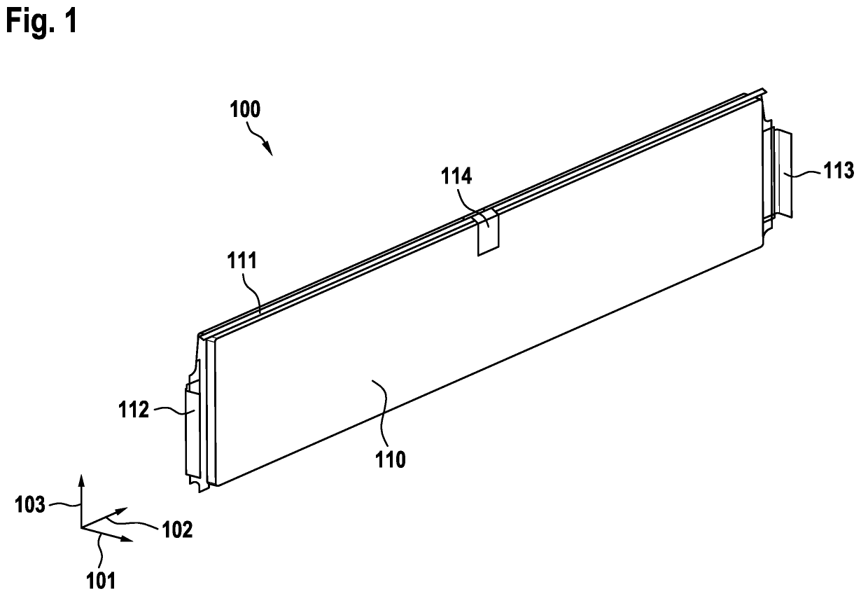

FIG. 1 schematically shows a perspective representation 100 of a pouch cell 110 in one embodiment of the method according to aspects of the invention. The pouch cell 110, which is formed primarily planarly in a pouch cell longitudinal direction 102 and in the direction of a pouch cell width 103, can be arranged together with identically formed pouch cells 110 to form a stack perpendicularly to its planar extent, i.e., in a direction along its pouch cell thickness, so to speak in the stacking direction 101. At its lower and upper edges along the pouch cell longitudinal direction, there respectively are a lower connecting lug 112 and an upper connecting lug to a battery welded within the pouch cell 110. A circumferential weld seam along the planar extent of the pouch cell 110 forms a fold 111. Centrally to the longitudinal extent of the pouch cell 110, the fold 111 is bent over and fixed to the pouch cell 110 by means of an adhesive tape 114.

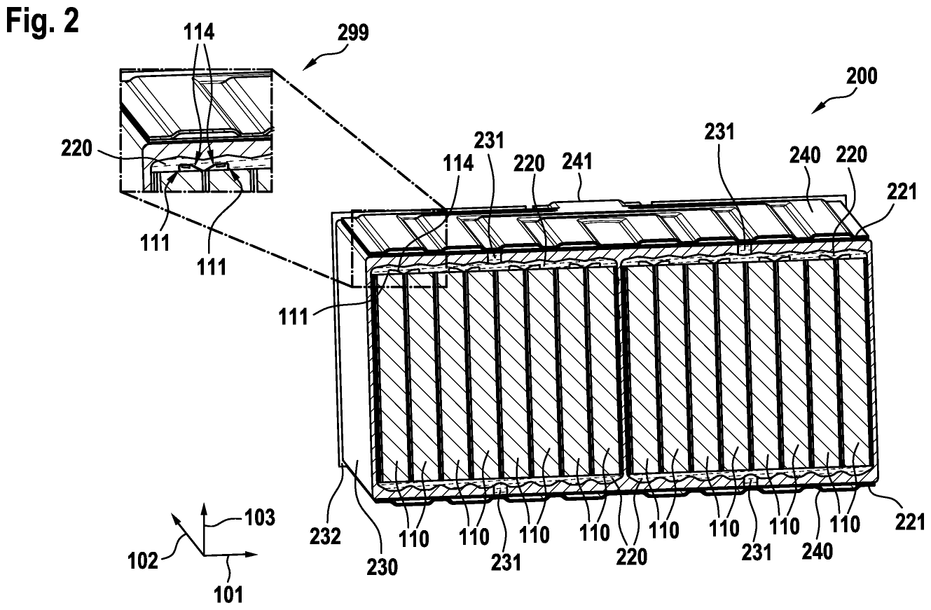

FIG. 2 schematically shows a sectional view 200 through a battery module in a further embodiment of the method according to aspects of the invention. A plurality of pouch cells 110 are arranged in a row in the stacking direction 101 within a module housing 230. The module housing 230 comprises a connecting plate 232, and upward and downward a respective cooling wall 221 on which a respective cooling plate with cooling fins 240 and a cooling system connector 241 are arranged. Filling openings 231, through which a thermal paste 220 is filled in prior to arranging the cooling plate with the cooling fins 240, are placed in the cooling wall 221. The thermal paste 220 fills an intermediate space between the pouch cells 110 and the respective cooling walls 221 of the module housing 230. In order to ensure according to aspects of the invention a first and a second flow channel for the thermal paste 220, the respective fold 111 of the pouch cells 110 is bent over and fixed with an adhesive tape 114. According to aspects of the invention, the fixing prevents the respective folds 111 from standing up when the thermal paste 220 flows in. The fixing of the respective folds 111 according to aspects of the invention by a respective adhesive tape 114 for unhindered conduction of the thermal paste 220 is illustrated enlarged in the diagram 299.

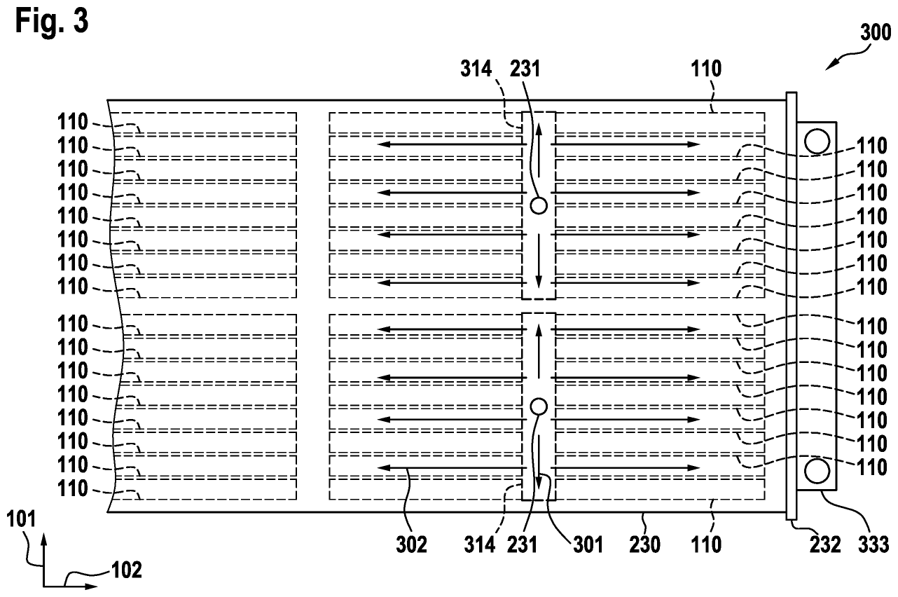

FIG. 3 schematically shows a phantom view 300 through the battery module with connecting plate 232 and connecting web 333 from above in a still further embodiment of the method according to aspects of the invention. Here, a respective adhesive tape 314 is guided centrally to the extent of the pouch cells 110 in the longitudinal direction 102 over the respective stack of pouch cells 110 in order to fix the respectively bent-over folds and to form a first flow channel. Advantageously, the respective filling opening 231 is arranged above the respective adhesive tape 314. Starting from the respective filling openings 231, the filled thermal paste in the first flow channel 301 first flows parallel to the stacking direction 101 in order to subsequently spread in the respective second flow channel 302 along the longitudinal direction 102 of the pouch cells 110.

### LIST OF REFERENCE NUMBERS

100 Perspective representation of a pouch cell
101 Direction along the pouch cell thickness: stacking direction
102 Pouch cell longitudinal direction
103 Direction along the pouch cell width
110 Pouch cell
111 Fold
112 Lower connecting lug
113 Upper connecting lug
114 Adhesive tape for fold fixing
200 Sectional view of a battery module
220 Thermal paste
221 Cooling wall
230 Module housing
231 Filling opening for thermal paste
232 Connecting plate
240 Cooling plate with cooling fins
241 Cooling system connector
299 Enlarged detail regarding fold adhesion
300 Phantom view of the battery module from above
301 Flow direction of first flow channel
302 Flow direction of second flow channel
314 Adhesive tape over a plurality of folds
322 Flow direction of the thermal paste in the first flow channel
333 Connecting web

What is claimed is:

1. A method for distributing a thermal paste into a battery module,
wherein the battery module comprises a module housing with at least one cooling wall, at which a cooling plate can be arranged outside the module housing,
at least one stack of pouch cells that is formed by a plurality of the pouch cells that are uniformly stacked on top of one another on their planar sides, wherein each pouch cell has (i) a rectangular surface with a length and a width, (ii) an edge disposed perpendicularly to the rectangular surface and having a pouch cell thickness, and (iii) a fold that extends along the edge,
wherein at least one stack cooling side of the stack of pouch cells is defined by a pouch cell longitudinal direction and a stacking direction formed in a direction of stacking, wherein the at least one stack of pouch cells is arranged at the at least one cooling wall in the module housing,
wherein at least one opening is disposed in the at least one cooling wall,
wherein, in proximity to the at least one opening, a fold, extending on the at least one stack cooling side of at least one pouch cell, is folded over toward the surface of said at least one pouch cell and fixed, thereby forming a first flow channel between the at least one stack cooling side and the at least one cooling wall,
said method comprising:
distributing the thermal paste through the at least one opening to cause the thermal paste to spread homogeneously in the first flow channel.

2. The method according to claim 1, in which the first flow channel is formed in the stacking direction and orthogonally to the pouch cell longitudinal direction by taping the fold and hollowing out a stack-side cooling wall.

3. The method according to claim 1, wherein a respective fold is individually fixed to its respective pouch cell.

4. The method according to claim 1, in which a respective fold is taped in a group with further folds with an adhesive tape arranged along the stacking direction.

5. The method according to claim 1, further comprising least one second flow channel formed orthogonally to the first flow channel by additionally bending over and taping at least one fold along the pouch cell longitudinal direction.

6. The method according to claim 5, in which the first flow channel is formed with a larger volume than the second flow channel by more narrowly taping and/or more strongly hollowing out the stack-side cooling wall, whereby, when the thermal paste is distributed, the thermal paste spreads first in the first flow channel and subsequently into the second flow channel.

7. A battery module comprising:
a module housing with at least one cooling wall, at which a cooling plate can be arranged outside the module housing,
at least one stack of the pouch cells that is formed by a plurality of pouch cells that are uniformly stacked on top of one another on their planar sides, wherein each pouch cell includes (i) a rectangular surface having a length and a width, (ii) an edge disposed perpendicularly to the rectangular surface and having a pouch cell thickness, and (iii) a fold that extends along the edge,
wherein at least one stack cooling side of the stack of pouch cells is defined by a pouch cell longitudinal direction and a stacking direction formed in a direction of stacking, wherein the at least one stack of pouch cells is arranged at the at least one cooling wall in the module housing,
at least one opening arranged in the at least one cooling wall,
wherein, in proximity to the at least one opening, a fold, extending on the at least one stack cooling side, of at least one pouch cell is folded over toward the surface of said at least one pouch cell and fixed, thereby forming a first flow channel between the at least one stack cooling side and the at least one cooling wall, and
wherein the at least one opening and the first flow channel are homogeneously filled with the thermal paste.

8. The battery module according to claim 7, wherein the first flow channel is formed in the stacking direction and orthogonally to the pouch cell longitudinal direction by taping the at least one fold and hollowing out the stack-side cooling wall.

9. The battery module according to claim 7, in which a respective fold is individually glued to its respective pouch cell.

10. The battery module according to claim 7, in which a respective fold is taped in a group with further folds with an adhesive tape arranged along the stacking direction.

11. The battery module according to claim 7, further comprising at least one second flow channel formed orthogonally to the first flow channel by additionally bending over and taping at least one fold along the pouch cell longitudinal direction.

12. The battery module according to claim 11, in which the first flow channel is formed with a larger volume than the second flow channel by more narrowly taping and/or more strongly hollowing out the stack-side cooling wall, whereby the first flow channel and the second flow channel are configured such that, when the thermal paste is filled in, the latter spreads first in the first flow channel and subsequently in the second flow channel.

13. A vehicle comprising the battery module of claim 7.
